(19) United States
(12) Patent Application Publication
(10) Pub. No.: US 2004/0032652 A1
(43) Pub. Date: Feb. 19, 2004

(54) Collapsible viewing instrument

(76) Inventors: Delores Naomi Holmes, Columbia, MD (US); Clarence Wooten JR., Clarksville, MD (US); Ravi Kumar Sawhney, Calabasas, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/217,139

(22) Filed: Aug. 13, 2002

(51) Int. Cl. G02B 23/00

(52) U.S. Cl. 359/408; 359/399; 359/402; 359/474; 359/817

(57) ABSTRACT

A viewing instrument that has a collapsed configuration and an expanded configuration. The viewing instrument includes two lenses that are located within a housing when the viewing instrument is in its collapsed configuration and at least a portion of each of the lenses is located outside of the housing when the viewing instrument is in its expanded configuration.

### BACKGROUND OF THE INVENTION

This invention relates generally to a viewing instrument, and in particular, to a viewing instrument that can be collapsed into a compact and portable configuration.

As many people age, it becomes necessary for them to use vision aids, such as eye glasses, to see things clearly, such as the small print of a restaurant menu or the price tag of a particular item. As many of these people did not require eye glasses early in life, they arc not in the habit of always wearing eye glasses or of always carrying eye glasses with them. Thus, convenient and portable viewing instruments have been developed.

Some conventional portable viewing instruments are small and compact in size. It may be difficult, however, for a user to use such small viewing instruments. Other conventional portable viewing instruments may be collapsed into a small and compact size. For example, the frame of the viewing instrument may be made of a resilient material to allow the frame to bend to permit the viewing instrument to the fit into the pocket of a user. The frames of these viewing instruments, however, may become deformed or may break while resting in the pocket of the user.

Thus, a need exists for a durable viewing instrument that can be easily transported by a user. A need also exists for a viewing instrument that is convenient for a user to transport without the user having to remember to carry the instrument.

### SUMMARY OF THE INVENTION

A collapsible viewing instrument has an expanded configuration and a collapsed configuration. The collapsible viewing instrument includes a protective housing and a frame. The housing can be coupled to a commonly transported item such as a key ring and defines a cavity. The frame includes a first frame portion, which has a first viewing lens coupled thereto, and a second frame portion, which has a second viewing lens coupled thereto. The first frame portion is pivotally coupled to the second frame portion.

When the collapsible viewing instrument is placed in its collapsed configuration, the first and second viewing lenses are located within the housing cavity. When the collapsible viewing instrument is placed in its expanded configuration, at least a portion of each of the first and the second viewing lenses is located outside of the housing cavity, and the housing becomes a handle such as with a lorgnette.

### BRIEF DESCRIPTION OF THE DRAWINGS

FIG. 1 is a perspective view of a collapsible viewing instrument according to an embodiment of the invention in its collapsed configuration.

FIG. 2 is a top view of the collapsible viewing instrument of FIG. 1 in its collapsed configuration.

FIG. 3 is a bottom view of the collapsible viewing instrument of FIG. 1 in its collapsed configuration.

FIGS. 4-7 are side views of the collapsible viewing instrument of FIG. 1 in its collapsed configuration.

FIG. 8 is a perspective view of the collapsible viewing instrument of FIG. 1 in its expanded configuration.

FIG. 9 is a top view of the collapsible viewing instrument of FIG. 1 in its expanded configuration.

FIG. 10 is a bottom view of the collapsible viewing instrument of FIG. 1 in its expanded configuration.

FIGS. 11-14 are side views of the collapsible viewing instrument of FIG. 1 in its expanded configuration.

FIG. 15 is an exploded view of the collapsible viewing instrument of FIG. 1.

FIG. 16 is a perspective view of a collapsible viewing instrument according to another embodiment of the invention.

FIG. 17 is a perspective view of a collapsible viewing instrument according to another embodiment of the invention.

FIG. 18 is a side view of the collapsible viewing instrument of FIG. 11.

FIG. 19 is an exploded view of a collapsible viewing instrument according to another embodiment of the invention.

FIG. 20 is a perspective view of a collapsible viewing instrument according to another embodiment of the invention.

FIG. 21 is a top view of a collapsible viewing instrument according to another embodiment of the invention in its collapsed configuration.

FIG. 22 is a bottom view of the collapsible viewing instrument of FIG. 21 in its collapsed configuration.

FIGS. 23-26 are side views of the collapsible viewing instrument of FIG. 21 in its collapsed configuration.

FIG. 27 is a perspective view of the collapsible viewing instrument of FIG. 21 in its expanded configuration.

FIG. 28 is a top view of the collapsible viewing instrument of FIG. 21 in its expanded configuration.

FIG. 29 is a bottom view of the collapsible viewing instrument of FIG. 21 in its expanded configuration.

FIGS. 30-33 are side views of the collapsible viewing instrument of FIG. 21 in its expanded configuration.

### DETAILED DESCRIPTION

A collapsible viewing instrument has an expanded configuration and a collapsed configuration. The collapsible viewing instrument includes a protective housing and a frame. The housing can be coupled to a commonly transported item such as a key ring and defines a cavity. The frame includes a first frame portion, which has a first viewing lens coupled thereto, and a second frame portion, which has a second viewing lens coupled thereto. The first frame portion is pivotally coupled to the second frame portion.

When the collapsible viewing instrument is placed in its collapsed configuration, the first and second viewing lenses are located within the housing cavity. When the collapsible viewing instrument is placed in its expanded configuration, at least a portion of each of the first and the second viewing lenses is located outside of the housing cavity, and the housing becomes a handle such as with a lorgnette.

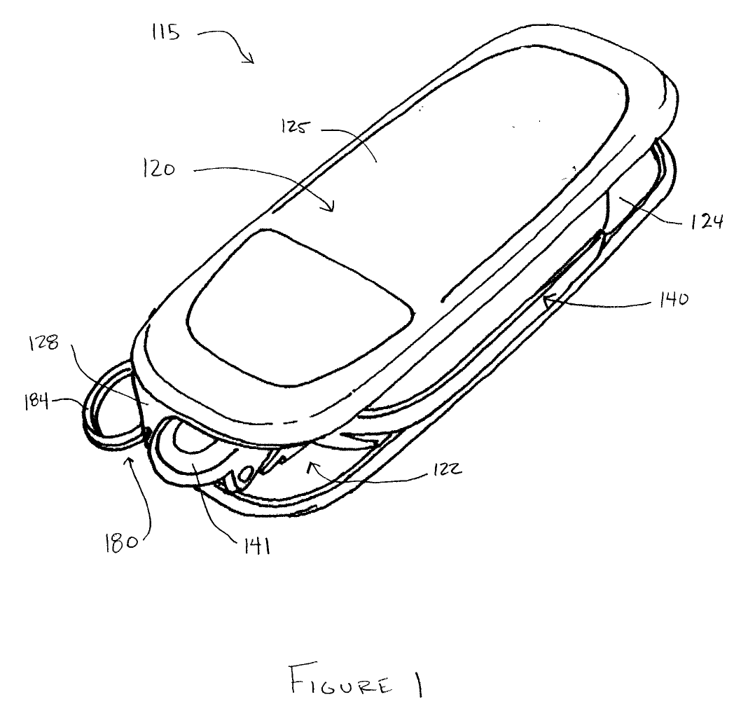

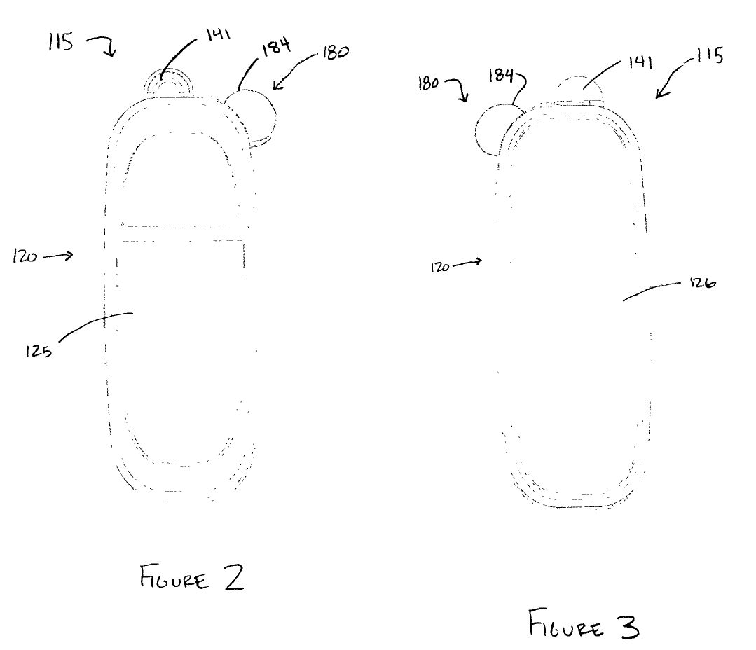

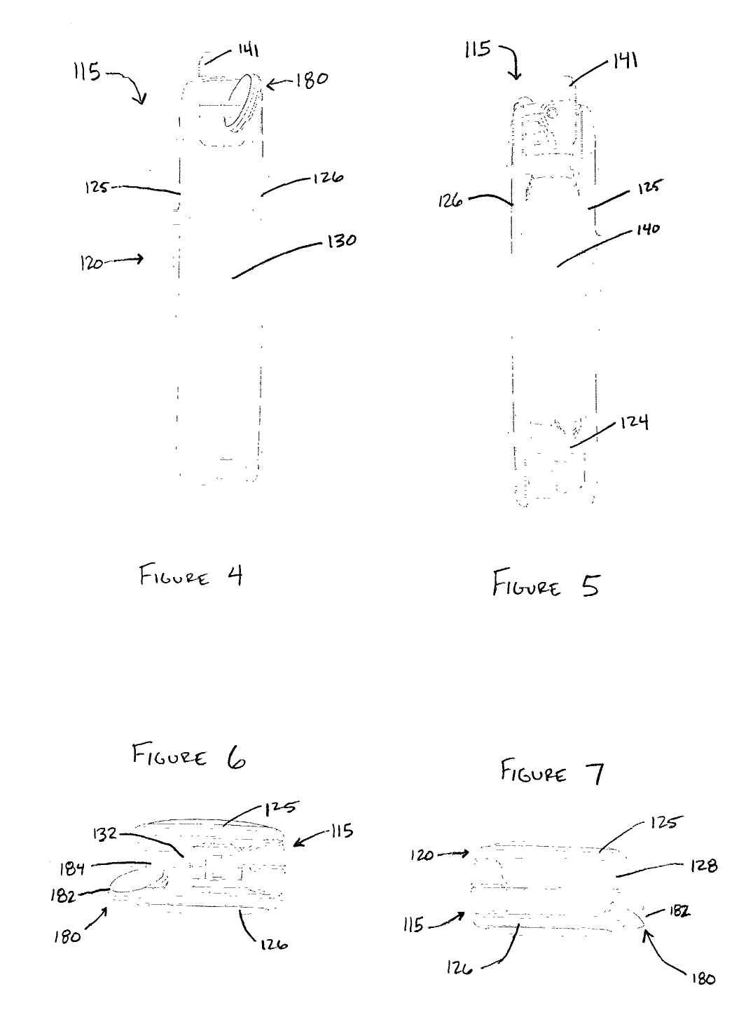

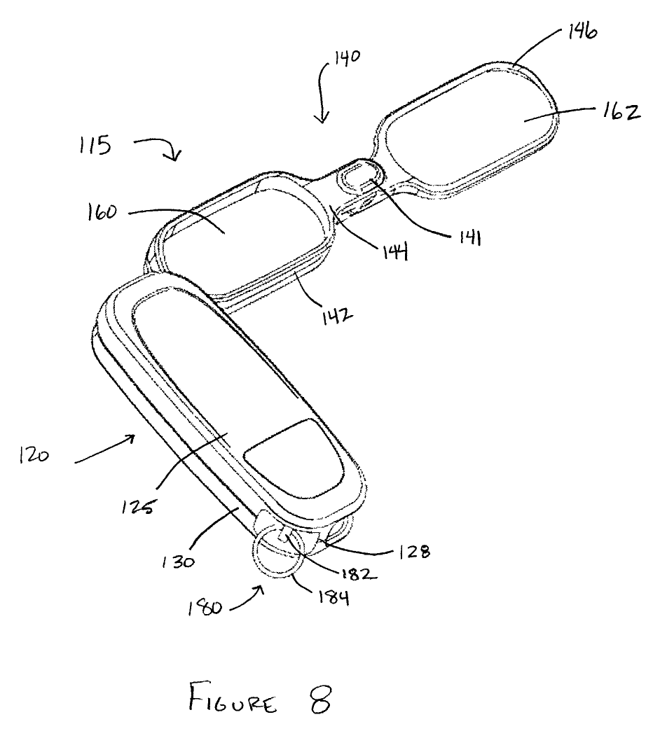

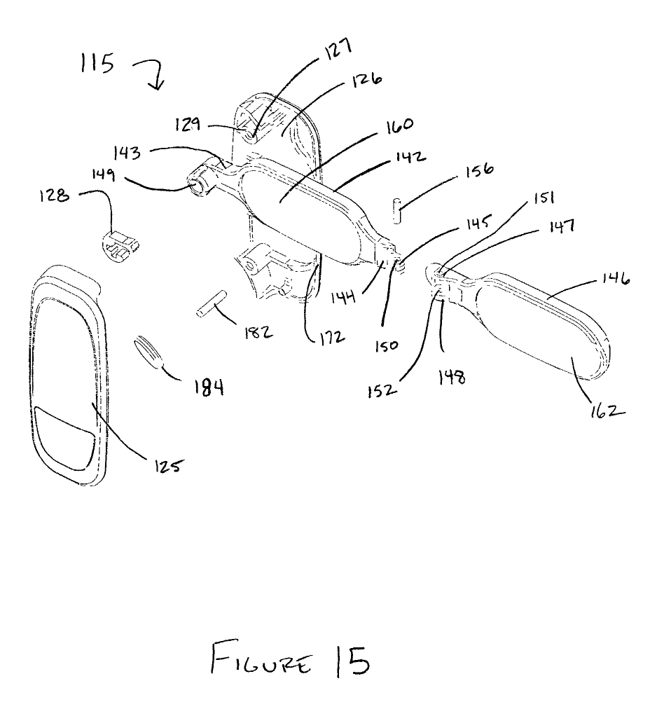

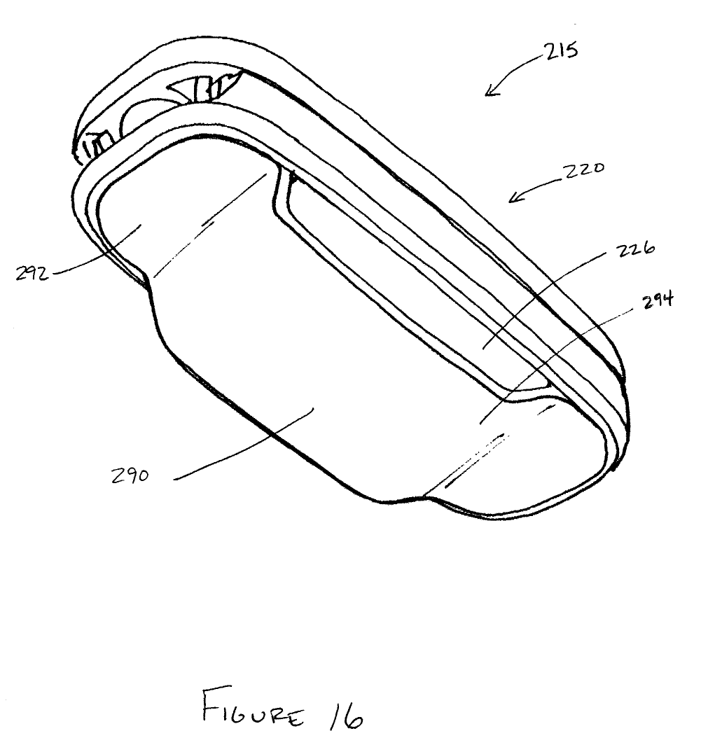

One embodiment of the collapsible viewing instrument is illustrated in FIGS. 1-15. In this embodiment, a collapsible viewing instrument 115 has an expanded configuration and a collapsed configuration. The collapsible viewing instrument 115 includes a housing 120 and a frame 140. The housing 120 includes an upper portion 125, a lower portion 126, and three side portions 128, 130, and 132, which define a cavity 122. The housing 120 also includes an opening 124 that communicates with the cavity 122. In the illustrated embodiment, the housing 115 is made of a rigid material, such as plastic or metal. In alternative embodiments, however, the housing is made of a flexible material, such as rubber or neoprene.

The frame 140 is a support structure that includes a first frame portion 142, a second frame portion 146, and a grip portion 141. The first frame portion 142 has a first end portion 143 and a second end portion 144. The first end portion 143 of the first frame portion 142 is coupled to the housing 120 for relative pivotal movement between the first frame portion and the housing. As best viewed in FIG. 15, in the illustrated embodiment, the housing 120 includes a protrusion 129 that extends through an opening 149 located proximate the first end portion 143 of the first frame portion 142 to pivotally couple the first frame portion to the housing. A cap 128 is coupled to the end 127 of the protrusion 129 to secure the first frame portion 142 to the protrusion. In alternative embodiments, other coupling mechanisms, such as brads, rivets, etc., are used to pivotally couple the first frame portion to the housing.

The second end portion 144 of the first frame portion 142 is coupled to the second frame portion 146 for relative pivotal movement between the first frame portion and the second frame portion. In the illustrated embodiment, the second end portion 144 of the first frame portion 142 includes a protrusion 145 that is configured to be received between two protrusions 147 and 148 that extend from the second frame portion 146. Protrusions 145, 147, and 148 include openings 150, 151, and 152, respectively. A pin 156 is configured to extend through openings 150, 151, and 152 to pivotally secure the first frame portion 142 to the second frame portion 146. In alternative embodiments, other coupling mechanisms, such as brads, rivets, etc., are used to pivotally couple the first frame portion to the second frame portion.

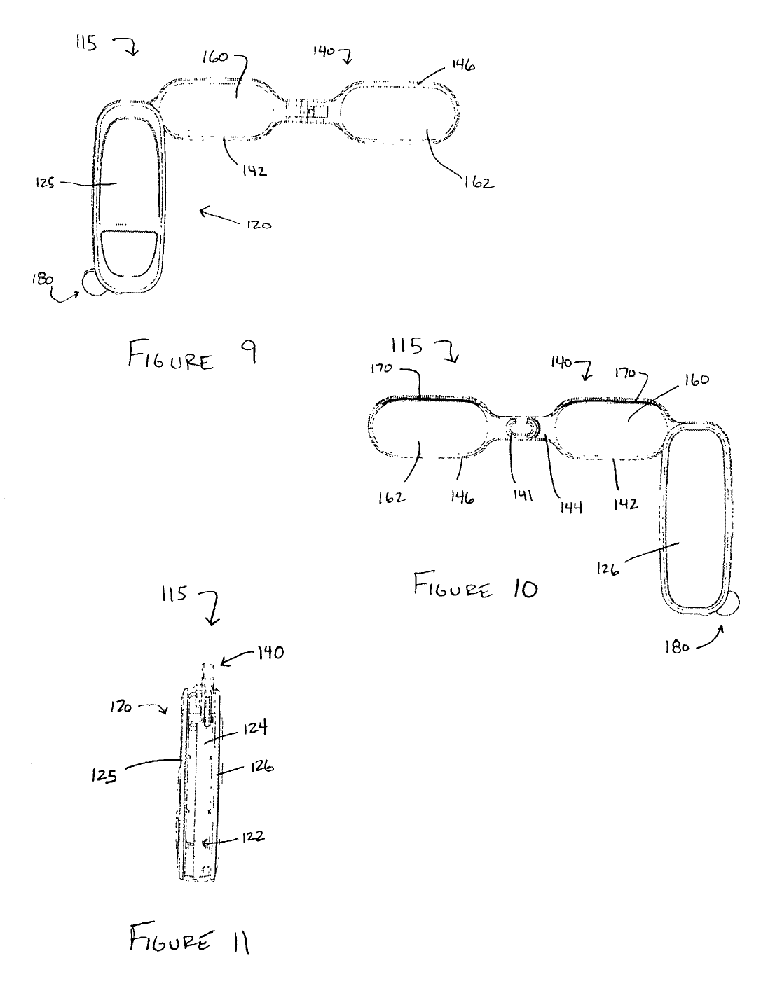

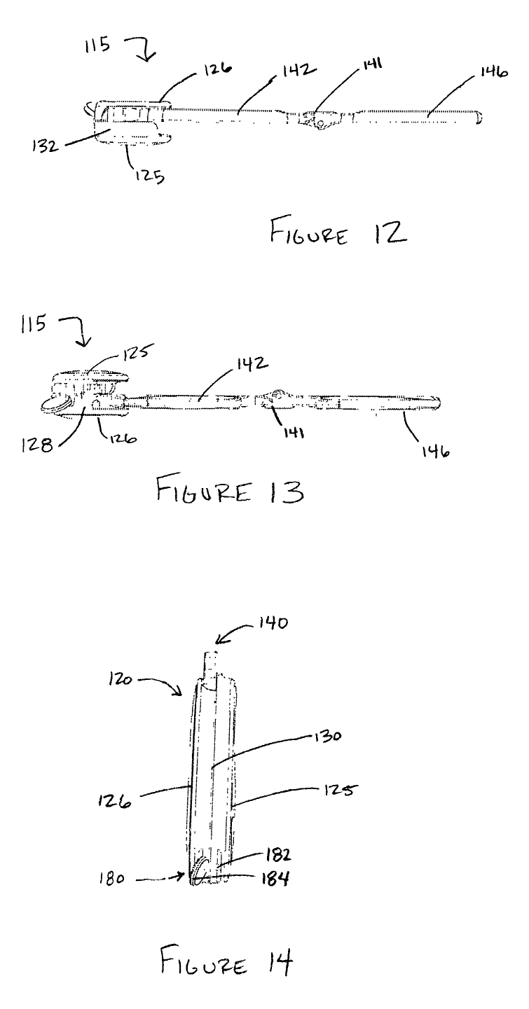

As best viewed in FIGS. 8 and 10, the grip portion 141 of the frame 140 is located between the first frame portion 142 and the second frame portion 146 when the first and second frame portions are in a side by side or expanded relationship. The grip portion 141, however, due to the location of the grip portion with respect to the pivotal coupling of the first and second frame portions 142 and 146, extends from the remainder of the frame 140 when the first and second frame portions are in an overlapping or collapsed configuration. This allows a user to grip and move the frame 140 with respect to the housing 120.

Similar to traditional viewing lenses, lenses 160 and 162 are transparent and aid a user in viewing objects. In one embodiment, the viewing lenses 160 and 162 are lenses that magnify in standard reading glass diopter strengths. In alternative embodiments, the viewing lenses are traditional magnifying type lenses, prescription type lenses, tinted (less than totally transparent) sunglasses.

Lenses 160 and 162 are coupled to and supported by the frame 140. In the illustrated embodiment, lenses 160 and 162 are snap fit to the first frame portion 142 and the second frame portion 146, respectively. The frame portions 142 and 146 each have a receiving track that extends around the inner perimeter of the frame portion to receive the lenses 160 and 162. In alternative embodiments, other conventional mechanical means, such at screws or rivets, or chemical means, such as an adhesive, are used to couple the lenses to the frame. Additionally, although in the illustrated embodiment the frame portions 142 and 146 extend around the entire perimeter of the lenses 160 and 162, it is not necessary that the frame portions extend around the entire perimeter of the lenses. In an alternative embodiment, the frame, or a portion of the frame, extends along only a portion of the perimeter of each of the lenses. In a further alternative embodiment, the frame does not extend around any part of the perimeter of the lenses.

As illustrated in FIGS. 1-7, the collapsible viewing instrument 115 may be placed in a collapsed configuration. When the collapsible viewing instrument 115 is in its collapsed configuration, the lenses 160 and 162 are housed within the cavity 122 of the housing 120. Similarly, the first and second frame portions 142 and 146 are housed within the cavity 122 of the housing 120 when the collapsible viewing instrument 115 is in its collapsed configuration. The grip portion 141 of the frame 140, however, extends from the housing cavity 122 when the collapsible viewing instrument 115 is in its collapsed con figuration.

To place the collapsible viewing instrument 115 in its collapsed configuration, the second frame portion 146 is pivoted with respect to the first frame portion 142 such that the first and second frame portions are arranged in an overlapping relationship. In the illustrated embodiment, the first frame portion 142 and the second frame portion 146 are sized such that first frame portion faces the second frame portion when the frame portions are arranged in an overlapping relationship. In an alternative embodiment, the first frame portion and the second frame portion are sized such that the first frame portion receives the second frame portion and second lens when the frame portions are arranged in an overlapping relationship. After the first and second frame portions 142 and 146 are placed in an overlapping relationship, the first frame portion is pivoted with respect to the housing 120 such that the first and second frame portions and the lenses 160 and 162 enter the cavity 122 of the housing 120 through the opening 124.

As best illustrated in FIGS. 10 and 15, the frame 140 includes a ridge 170 and the housing 120 includes a groove 172. The ridge 170 and the groove 172 are configured to engage when the collapsible viewing instrument 115 is placed in its collapsed configuration. The engagement of the ridge 170 and the groove 172 helps prevent dirt and lint from entering into the housing cavity 122 while the lenses 160 and 162 are located therein. Additionally, the engagement of the ridge 170 and the groove 172 helps secure the collapsible viewing instrument 115 in its collapsed configuration and to prevent undesired expansion of the collapsible viewing instrument.

In the illustrated embodiment, ridges 170 arc located on upper parts of the first and second frame portions 142 and 146 (shown in FIG. 10). Grooves 172 are located on the inner side of the upper portion 125 of the housing (not shown in FIG. 15) and on the inner side of the lower portion 126 of the housing (shown in FIG. 15). The groves 172 are configured to engage the ridges 170 when the collapsible viewing instrument 115 is in its collapsed configuration. It is not necessary that the ridge be located on the frame and the groove be located on the housing. In an alternative embodiment, the ridge is located on the housing and the groove is located on the frame. In a further alternative embodiment, the housing 120 and the frame 140 each include flexible portions, such as rubber strips, that engage one another when the collapsible viewing instrument 115 is in its collapsed configuration. In a further alternative embodiment, a ridge is located both sides of the upper part of the first frame portion. In a further alternative embodiment, a single ridge is located on one side of the frame and a corresponding single groove is located on the inner surface of the housing.

As illustrated in FIGS. 8-14, the collapsible viewing instrument 115 may be placed in an expanded configuration. In its expanded configuration, the frame 140, including the first frame portion 142 and the second frame portion 146 extend from the housing with the first and second frame portions in a side by side relationship. Therefore, when the collapsible viewing instrument 115 is in its expanded configuration, at least a portion of each of the lenses 160 and 162 are located outside of the housing cavity 122.

To place the collapsible viewing instrument 115 in its expanded configuration, using the grip portion 141 of the frame 140, the first frame portion 142 is pivoted with respect to the housing 120 such that it extends from the housing. The second frame portion 146 is then pivoted with respect to the first frame portion 142 such that the second frame portion extends from the first frame portion in a side by side relationship. In its expanded configuration, the housing 120 of the collapsible viewing instrument 115 are held in the hand of a user such that the lenses 160 and 162 are located proximate the eyes of the user to assist the user in viewing a object and to give the user a full view of the object. To allow the user to hold the housing 120 with either hand, in the one embodiment the first frame portion 142 may be pivoted approximately 90° with respect to the housing 120 or alternatively may be pivoted approximately 270° with respect to the housing.

As illustrated in FIGS. 1-15, the collapsible viewing instrument also includes a coupler 180. The coupler 180 is coupled to the housing 120 and is configured to be removably coupled to a key ring. Although the term “removably” is used to describe the coupling of the collapsible viewing instrument 115 to the key ring, the collapsible viewing instrument is coupled to a key ring for everyday use (i.e., typically coupled so that the collapsible viewing instrument remains with the key ring) but may be removed from the key ring as desired by a user. In the illustrated embodiment, the housing includes a pin 182 that extends through a ring 184 to thereby couple the ring to the housing. Similar to a conventional key, the ring 184 is removably coupled to a key ring. In a further alternative embodiment, the coupler is any other device known in the art that may be used to removably couple the collapsible viewing instrument to a key ring such as, for example, a male connection device that is configured to be removably coupled to a corresponding female connection device that is coupled to a key ring. In further alternative embodiments, the coupler is configured to removably couple the collapsible viewing instrument to other items such as a neck rope or chain or a wheelchair arm.

Although collapsible viewing instrument 115 is illustrated and described as including a first frame portion 142, a second frame portion 146, a first lens 160, and a second lens 162, it is contemplated that alternative embodiments of the collapsible viewing instrument can include a single frame portion and a single lens for placement proximate to the eye for full field viewing. Such an alternative embodiment can be similar to that shown in FIGS. 1-15 except the second frame portion 146, the second lens 162, and the pin 156 are not present.

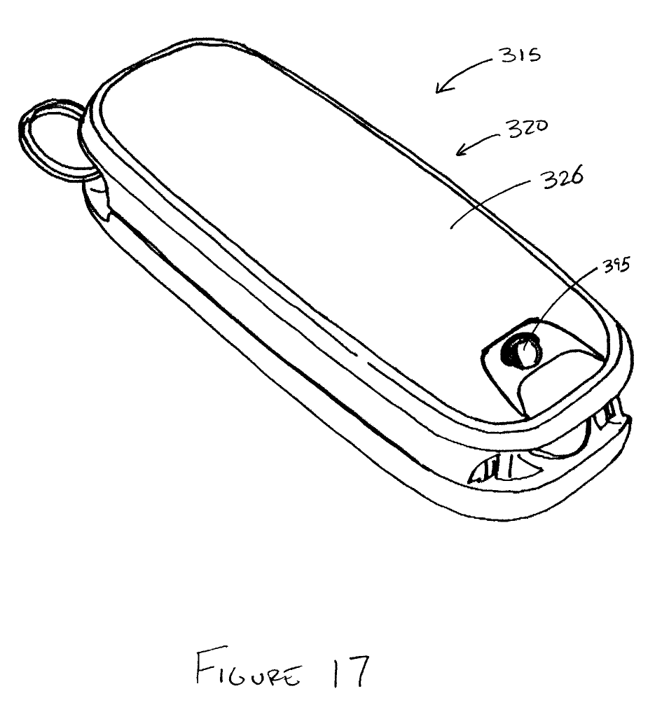

As illustrated in FIG. 16, an alternative embodiment of the collapsible viewing instrument 215 includes a clip 290. The clip 290 is coupled to the housing 220 and is configured to removably couple the collapsible viewing instrument 215 to an article of clothing. In the illustrated embodiment, the clip 290 is made of a rigid material, such as plastic. One end 292 of the clip 290 is coupled via an adhesive, or any other type of connection mechanism known in the art, to an outside surface of the lower portion 226 of the housing 220. An article of clothing, such as a belt, a portion of a shirt pocket, or a portion of a pants pocket, may be slid between the clip 290 and the housing 220 at clip portion 294 to removably couple the collapsible viewing instrument 215 to the article of clothing.

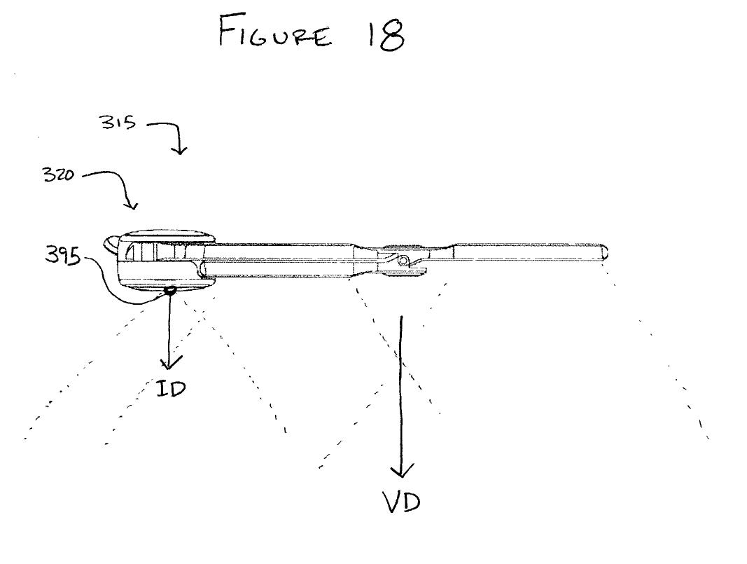

FIGS. 17 and 18 illustrate an alternative embodiment of the invention. Collapsible viewing instrument 315 includes a light source 395. As shown in FIG. 18, the light source 395 has an illumination direction (ID) that is substantially parallel to the viewing direction (VD) of the lenses. Thus, the light source 395 is configured to illuminate an object to be viewed by a user through the lenses. The ID can be defined, for example, by the direction of the majority or the centermost portion of the light emitted by light source 395. The VD can be defined, for example, by the center region within the field of view of the lenses that are coupled to the housing 320. The collapsible viewing instrument 315 also includes a power source (not shown), such as a battery, that is configured to provide power to the light source 395.

Although collapsible viewing instrument 315 is illustrated as including a first frame portion, a second frame portion, a first lens, and a second lens, it is contemplated that alternative embodiments of the collapsible viewing instrument includes a single frame portion and a single lens for placement proximate to the eye for full field viewing. In such an embodiment, the VD is defined by the center region within the field of view of the single lens.

In the illustrated embodiment, the light source 395 is a light emitting diode. The light source 395, however, may be a light bulb or any other light source capable of illuminating an object to be viewed by a user through the lenses of the collapsible viewing instrument 315. In the illustrated embodiment, the light source is positioned on the outside surface of the lower portion 326 of the housing 320. The light source 395, however, may be positioned at any location on the housing, including, but not limited to, within the housing, so long as the light source is positioned to illuminate an object to be viewed by a user through the lenses of the collapsible viewing instrument 315.

As illustrated in FIG. 19, an alternative embodiment of the collapsible viewing instrument 415 is a mechanically expanding viewing instrument. Collapsible viewing instrument 415 includes a spring 476, a retainer 477, and an actuator 478. The spring 476 is located within the housing cavity 422 and is configured to engage with the housing 420 and the frame 440 to bias the collapsible viewing instrument 415 into its expanded configuration.

The retainer 477 is located within the housing cavity 422 and is configured to engage the spring 476. The engagement of the retainer 477 and the spring 476 overcomes the bias of the spring against the frame 440. Thus, when the retainer 477 is engaged with the spring 476, the collapsible viewing instrument 415 is retained in its collapsed configuration.

The actuator 478 is configured to, when actuated, release the retainer 477 from its engagement with the spring 476. The spring 477 will thus bias the frame 440 away from the housing 420, thereby ejecting the frame from the housing cavity. In an alternative embodiment, the spring is biases the frame such that when the actuator is actuated the spring will eject the frame from the housing cavity and cause the second frame portion to pivot with respect to the first frame portion, thereby placing the collapsible viewing instrument 415 in its expanded configuration. In the illustrated embodiment, the actuator 478 is coupled to the retainer 477 and extends into the housing 420. The actuator 478 is pivotally coupled to the upper portion 425 of the housing 420 and is activated when it is pivoted with respect to the housing.

Although collapsible viewing instrument 415 is illustrated as including a first frame portion, a second frame portion, a first lens, and a second lens, it is contemplated that the collapsible viewing instrument may include a single frame portion and a single lens.

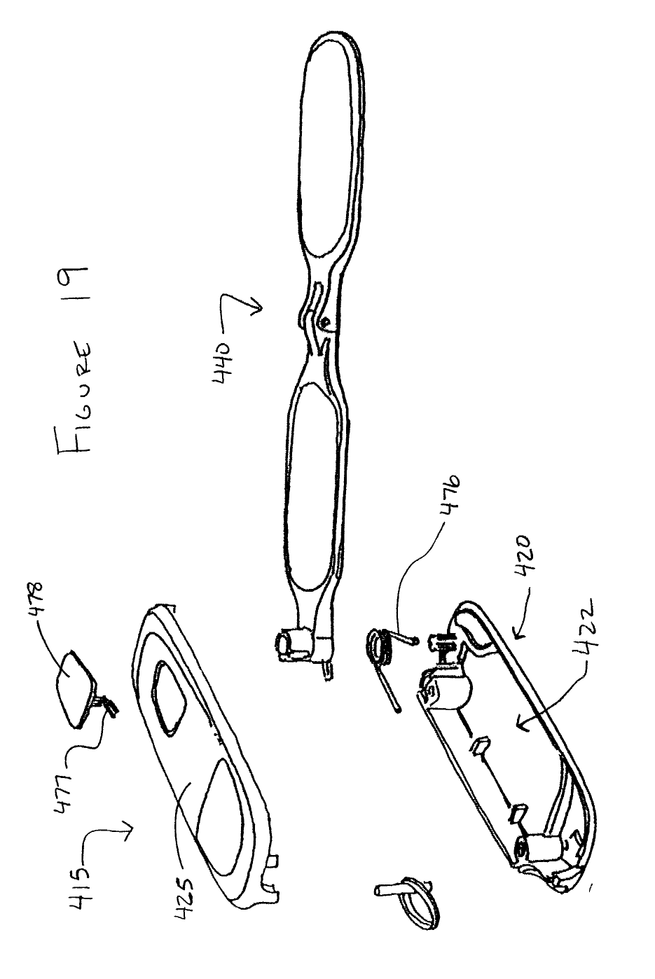

As illustrated in FIG. 20, an alternative embodiment of the collapsible viewing instrument 515 includes a housing 520 and a frame 540. In this embodiment, the frame 520 is not pivotally coupled to the housing 520. Rather, the frame 540 can be placed through the opening 524 and into the housing cavity 522 to place the collapsible viewing instrument 515 in its collapsed configuration. When the collapsible viewing instrument 515 is in its expanded configuration, the frame 540 can be completely removed from the housing 520.

Although collapsible viewing instrument 515 is illustrated as including a first frame portion, a second frame portion, a first lens, and a second lens, it is contemplated that alternative embodiments of the collapsible viewing instrument may include a single frame portion and a single lens for placement proximate to the eye for full field viewing.

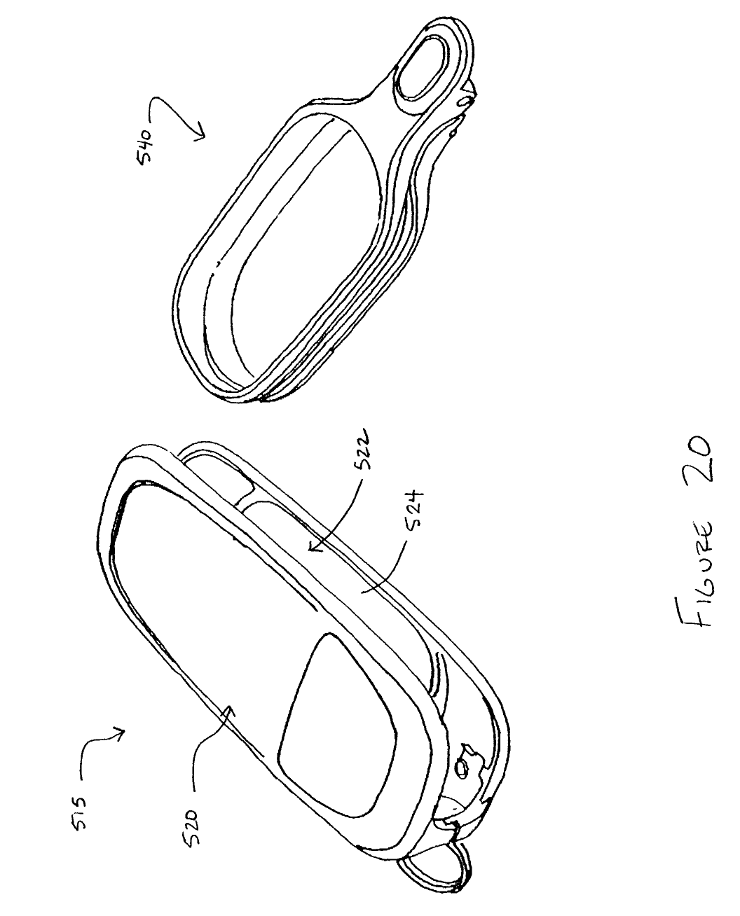

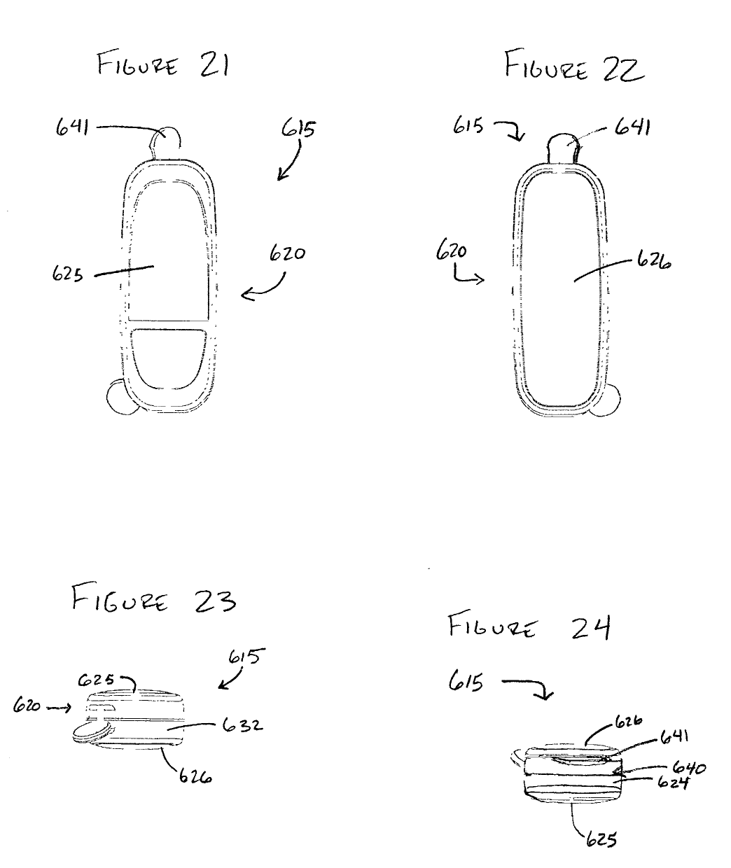

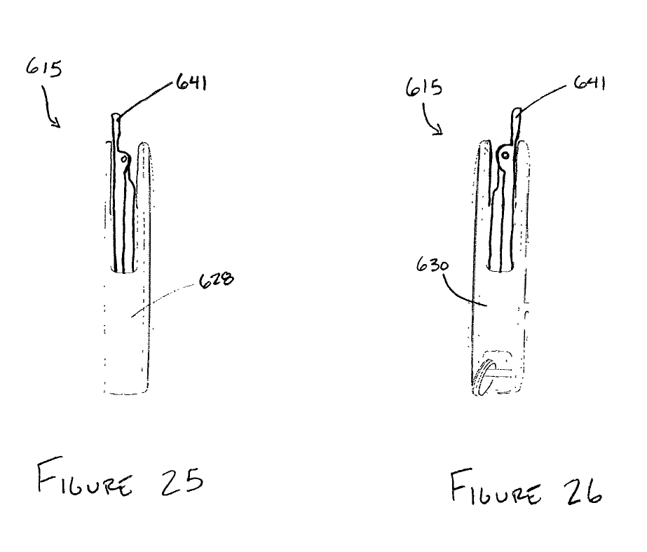

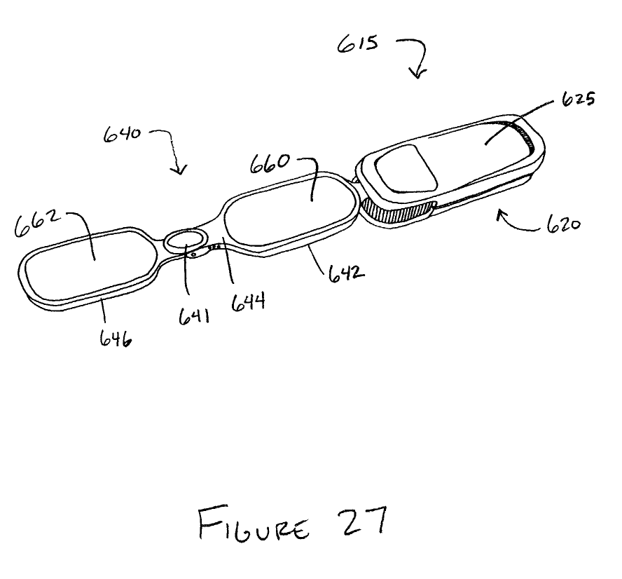

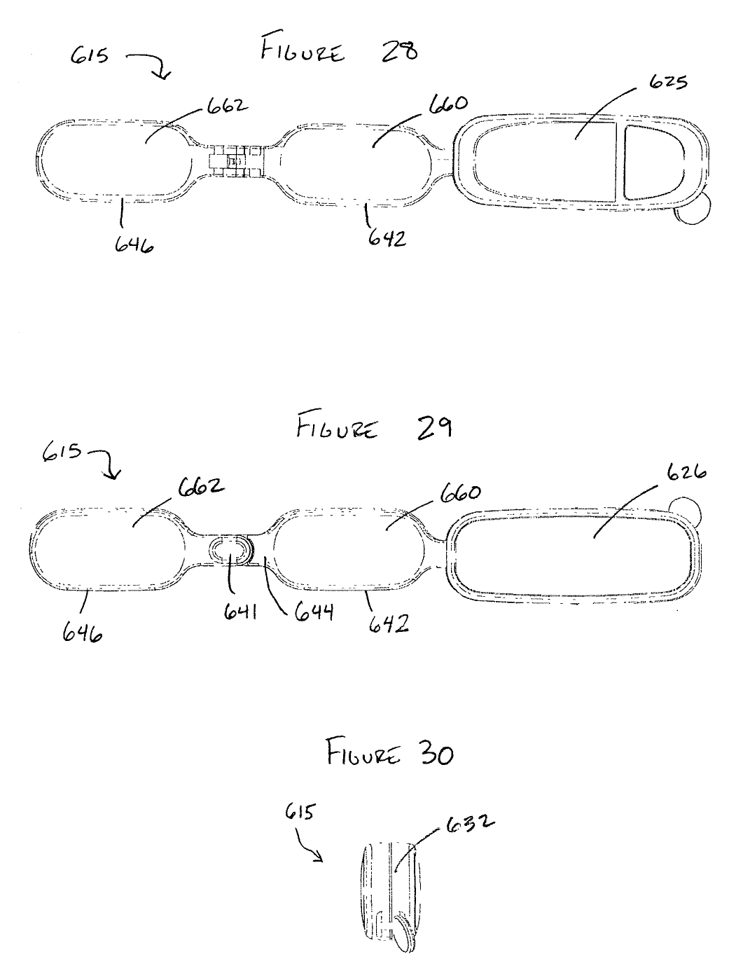

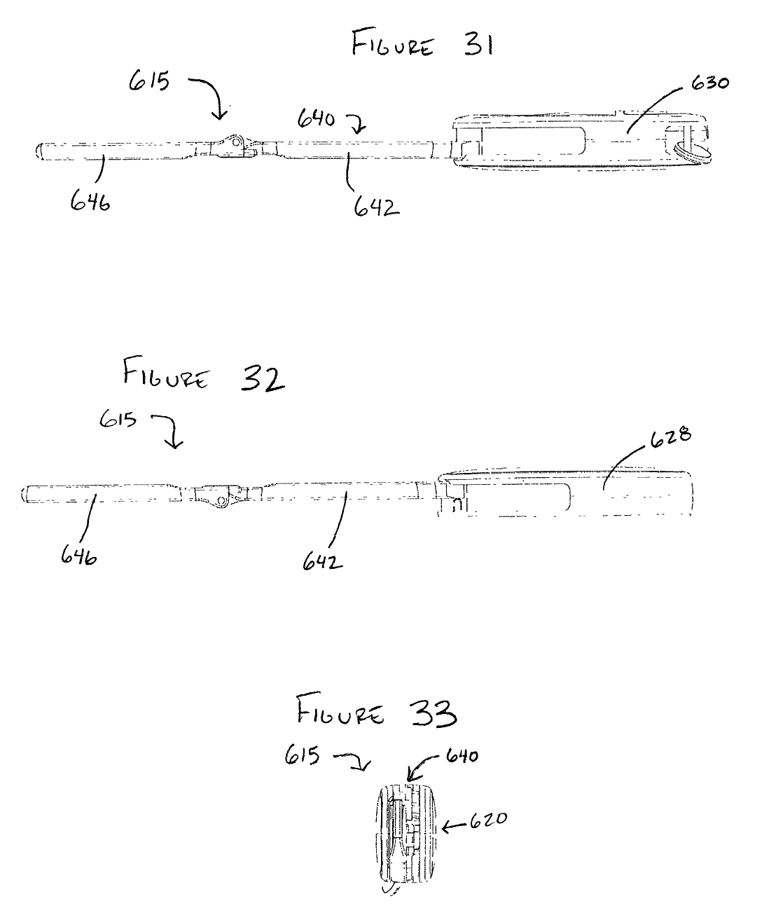

As illustrated in FIGS. 21-33, in an alternative embodiment of the collapsible viewing instrument 615 includes a housing 620 and a frame 640. The housing 620 defines a cavity 622 and includes an upper portion 625, a lower portion 626, and three side portions 628, 630, and 632. The housing 620 also includes an opening 624 that communicates with the housing cavity 622. The frame 640 includes a first frame portion 642, which has a first lens 660 coupled thereto, a second frame portion 646, which has a second lens 662 coupled thereto, and a grip portion 641.

In this embodiment, the first frame portion 642 is slidably coupled to the housing 620. Thus, to place the collapsible viewing instrument 615 in its expanded configuration, a user, using the grip portion 641 of the frame 640, slides the frame with respect to the housing 620. The second frame portion 646, which is pivotally coupled to one end 641 of the first frame portion 642, is then pivoted with respect to the first frame portion. Any known method may be used to slidably couple the first frame portion 642 to the housing 620. For example, a part of the first frame portion may traverse along a longitudinal groove located within the housing cavity.

In an alternative embodiment, the first frame portion is not pivotally coupled to the second frame portion. Instead, the first frame portion and the second frame portion are disposed substantially within the same plane.

Although collapsible viewing instrument 615 is illustrated and described as including a first frame portion 642, a second frame portion 646, a first lens 660, and a second lens 662, it is contemplated that alternative embodiments of the collapsible viewing instrument includes a single frame portion and a single lens for placement proximate to the eye for full field viewing.

While the invention has been described in detail and with reference to specific embodiments thereof, it will be apparent to one skilled in the art that various changes and modifications can be made therein without departing from the spirit and scope thereof. Thus, it is intended that the present invention covers the modifications and variations of this invention provided they come within the scope of the appended claims and their equivalents.

What is claimed is:

1. A viewing instrument having a collapsed configuration and an expanded configuration and comprising:
a housing;
a frame having a first lens portion and a second lens portion, said frame being coupled to said housing, the first lens portion of said frame includes a first end being coupled to said housing and a second end being pivotally coupled to the second lens portion of said frame;
a first lens coupled to the first lens portion of said frame and being located within said housing when the viewing instrument is in its collapsed configuration and at least a portion of said first lens being located outside of said housing when the viewing instrument is in its expanded configuration; and
a second lens coupled to the second lens portion of said frame and being located within said housing when the viewing instrument is in its collapsed configuration and at least a portion of said second lens being located outside of said housing when the viewing instrument is in its expanded configuration.

2. The viewing instrument of claim 1, wherein said housing includes a coupler.

3. The viewing instrument of claim 2, wherein said coupler is configured to removably couple said housing to a key ring.

4. The viewing instrument of claim 1, wherein said housing includes a clip configured to removably couple said housing to an article of clothing.

5. The viewing instrument of claim 1, further comprising a light source coupled to said housing, the light source having an illumination direction, the viewing instrument having a vision direction, the illumination direction being substantially parallel to the vision direction.

6. The viewing instrument of claim 1, further comprising a spring coupled to said housing and to said frame and configured to bias the viewing instrument in its expanded configuration.

7. The viewing instrument of claim 1, further comprising:
a spring housed within said housing and configured to engage said housing and said frame to bias the viewing instrument to its expanded configuration;
a retainer configured to overcome the bias of said spring and retain the viewing instrument in its collapsed configuration; and
an actuator extending into said housing and configured to selectively release the retainer to actuate the spring, thereby converting the viewing instrument into its expanded configuration.

8. The viewing instrument of claim 1, wherein said first lens portion is pivotally coupled to said housing.

9. The viewing instrument of claim 1, wherein said first lens portion is slidably coupled to said housing.

10. A viewing instrument having a collapsed configuration and an expanded configuration comprising:
a housing;
a frame;
a groove located on one of said housing and said frame; and
a ridge located on the other of said housing and said frame, said ridge being configured to engage said groove when the viewing instrument is in its collapsed configuration.

11. The viewing instrument of claim 10, wherein said housing includes a coupler.

12. The viewing instrument of claim 11, wherein said coupler is configured to removably couple said housing to a key ring.

13. The viewing instrument of claim 10, wherein said housing includes a clip configured to removably couple said housing to an article of clothing.

14. The viewing instrument of claim 10, further comprising a light source coupled to said housing, the light source having an illumination direction, the viewing instrument having a vision direction, the illumination direction being substantially parallel to the vision direction.

15. A viewing instrument having a collapsed configuration and an expanded configuration and comprising:
a housing;
a frame having a first lens portion, a second lens portion, and a grip portion, the first lens portion and the second lens portion being configured to be located within the housing when the viewing instrument is in its collapsed configuration, the grip portion being configured to actuate the first lens portion and the second lens portion away from the housing;
a first lens coupled to the first lens portion of said frame; and
a second lens coupled to the second lens portion of said frame.

16. The viewing instrument of claim 15, wherein said housing includes a coupler.

17. The viewing instrument of claim 16, wherein said coupler is configured to removably couple said housing to a key ring.

18. The viewing instrument of claim 15, wherein said housing includes a clip configured to removably couple said housing to an article of clothing.

19. The viewing instrument of claim 15, further comprising a light source coupled to said housing, the light source having an illumination direction, the viewing instrument having a vision direction, the illumination direction being substantially parallel to the vision direction.

20. A viewing instrument having a collapsed configuration and an expanded configuration and comprising:
a housing having an upper portion, a lower portion, and a single opening;
a frame having a first lens portion and a second lens portion;
a first lens coupled to the first lens portion of said frame, said first lens being configured to pass through the opening of said housing, said first lens being located within said housing when the viewing instrument is in its collapsed configuration and at least a portion of said first lens being located outside of said housing when the viewing instrument is in its expanded configuration; and
a second lens coupled to the second lens portion of said frame, said first lens being configured to pass through the opening of said housing, said second lens being located within said housing when the viewing instrument is in its collapsed configuration and at least a portion of said second lens being located outside of said housing when the viewing instrument is in its expanded configuration.

21. The viewing instrument of claim 20, wherein said housing includes a coupler.

22. The viewing instrument of claim 21, wherein said coupler is configured to removably couple said housing to a key ring.

23. The viewing instrument of claim 20, wherein said housing includes a clip configured to removably couple said housing to an article of clothing.

24. The viewing instrument of claim 20, further comprising a light source coupled to said housing, the light source having an illumination direction, the viewing instrument having a vision direction, the illumination direction being substantially parallel to the vision direction.

25. A viewing instrument comprising:
a housing having a clip configured to removably couple said housing to an article of clothing;
a frame having a collapsed configuration and an expanded configuration; said frame including a grip portion, a first lens portion, a second lens portion, a hinge pivotally coupling the first lens portion of said frame to the second lens portion of said frame, the first lens portion and the second lens portion being in an overlapping relationship when said frame is in its collapsed configuration, the first lens portion and the second lens portion being in a side by side relationship when said frame is in its expanded configuration;
a first lens coupled to said first lens portion of said frame; and
a second lens coupled to said second lens portion of said frame, the housing being configured to receive the first lens portion of said frame and the second lens portion of said frame when said frame is in its collapsed configuration, the grip portion of said frame being configured to actuate the first lens portion and the second lens portion away from the housing.

26. A method of converting a viewing instrument from a collapsed configuration to an expanded configuration, the viewing instrument having a housing, a frame including a first lens portion pivotally coupled to the housing, a second lens portion pivotally coupled to the first lens portion, a first lens coupled to the first lens portion, and a second lens coupled to the second lens portion, the method comprising:
pivoting the first lens portion with respect to the housing; and
pivoting the second lens portion with respect to the first lens portion.

27. A method of converting a viewing instrument from a collapsed configuration to an expanded configuration, the viewing instrument having a housing, a frame including a first lens portion slidably coupled to the housing, a second lens portion pivotally coupled to the first lens portion, a first lens coupled to the first lens portion, and a second lens coupled to the second lens portion, the method comprising:
sliding the first lens portion with respect to the housing; and
pivoting the second lens portion with respect to the first lens portion.
